(19) United States
(12) Patent Application Publication
(10) Pub. No.: US 2026/0323394 A1
(43) Pub. Date: Oct. 15, 2026

(54) USER SCENARIO-BASED SOLUTIONS FOR PERFORMANCE OPTIMIZATION IN ELECTRONIC STORE LABEL NETWORKS

(71) Applicant: QUALCOMM Incorporated, San Diego, CA (US)

(72) Inventors: Xin WU, Shanghai (CN); Nicolas GRAUBE, Cambridge (GB); Daqing LI, Suzhou (CN); Jie ZHANG, Shanghai (CN); Feng CHEN, Shanghai (CN); Xiuzhuo SHANG, Shanghai (CN)

(21) Appl. No.: 18/998,735

(22) PCT Filed: Sep. 2, 2022
(86) PCT No.: PCT/CN2022/116709

§ 371 Date: Jan. 27, 2025

(51) Int. Cl. H04W 28/16; G09F 3/20

(52) U.S. Cl. CPC H04W 28/16; G09F 3/208

(57) ABSTRACT

Various embodiments include methods performed by an access point (AP) for supporting communications of an electronic shelf label (ESL) network and a wireless local area network (WLAN). Embodiments may include implementing a coexistence communication priority policy for communications with ESLs and the WLAN in response to a change in an ESL network operating mode, sharing the coexistence communication priority policy with WLAN firmware of the AP, and using the coexistence communication priority policy in communications with ESLs. The coexistence communication priority policy may alter allocations of sub-slots within a frame structure of an ESL protocol to adjust the time available for packet transmissions in the WLAN and transmissions to and from ESLs. The coexistence communication priority policy may be selected from predefined sets of coexistence communication priority policies stored in the AP, wherein each of the sets of coexistence communication priority policies is customized for different ESL network communication scenarios.

### CROSS-REFERENCE TO RELATED APPLICATIONS

The present Application for Patent is a national stage application, filed under 35 U.S.C. § 371, of International Patent Application No. PCT/CN2022/116709, entitled, “USER SCENARIO-BASED SOLUTIONS FOR PERFORMANCE OPTIMIZATION IN ELECTRONIC STORE LABEL NETWORKS”, filed Sep. 2, 2022, which is assigned to the assignee hereof and is expressly incorporated herein by reference in its entirety.

### BACKGROUND

Electronic Shelf Labels (ESLs) have been introduced in supermarkets, supply stores, warehouses, and the like to improve inventory tracking, product mapping, price change rollouts, and the customer experience generally. The ESLs and a management entity server or other computing device may communicate wirelessly via an Access Point (AP) to manage the ESLs, as well as the data associated with the ESLs. Meanwhile, such facilities often provide a Wireless Local Area Network (WLAN) capability, such as Wi-Fi, for associates, customers, and/or other support systems. However, ESL and WLAN communications may compete for wireless resources when the AP is configured to support both communication protocols.

### SUMMARY

Various aspects of the present disclosure include methods, systems, and devices for managing communications of an electronic shelf label (ESL) network and a wireless local area network (WLAN) supported by an access point (AP) configured to support wireless communications with both the ESL network and the WLAN.

Various aspects performed by a processor of an the AP may include implementing a coexistence communication priority policy for communications with ESLs and the WLAN in response to a change in an ESL network operating mode, sharing the coexistence communication priority policy with WLAN firmware of the AP, and using the coexistence communication priority policy in communications with ESLs.

In some aspects, implementing the coexistence communication priority policy includes altering allocations of sub-slots within a frame structure of an ESL protocol to adjust a ratio of time available for packet transmissions in the WLAN and transmissions to and from ESLs. Some aspects may further include selecting the coexistence communication priority policy from predefined sets of coexistence communication priority policies stored in the AP, wherein each of the sets of coexistence communication priority policies is customized for different ESL network communication scenarios.

In some aspects, each set of coexistence communication priority policies may define a priority level of WLAN or ESL communications based on traffic loads for different types of traffic between the WLAN and ESLs. In some aspects, the coexistence communication priority policy may be configured to enable an ESL to transmit during a WLAN packet transmission or reception time. In some aspects, the coexistence communication priority policy may be configured to enable the WLAN to transmit during an ESL sub-slot. In some aspects, the coexistence communication priority policy may define at least one dedicated sub-slot within at least one of an active group or a passive group of time slots for ESL communications. In some aspects, implementing the coexistence communication priority policy may include at least one of dynamic sub-slot reallocation or dynamic priority setting. In some aspects, the change in the ESL network communication operating mode may involve a change to one of an onboarding of ESLs operating mode, a synchronization of ESLs operating mode, an ESL operating code update or setup operating mode, a stable ESL operating mode, or a default operating mode.

Further aspects include an AP configured with a processor for performing one or more operations of any of the methods summarized above. Further aspects include a non-transitory processor-readable storage medium having stored thereon processor-executable instructions configured to cause a processor of an AP to perform operations of any of the methods summarized above. Further aspects include an AP having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram illustrating an ESL network and a WLAN network supported by a single AP suitable for implementing any of the various embodiments.

FIG. 2 is a component block diagram illustrating an example computing and wireless modem system on a chip suitable for use in a computing device implementing any of the various embodiments.

FIG. 3 is a dynamic ESL user scenario configuration table according to various embodiments.

FIG. 4 is a communication flow diagram illustrating a method for optimizing performance of an ESL network sharing remote network access through the AP with a wireless local area network WLAN according to various embodiments.

FIG. 5A is a graph of an ESL traffic pattern of active and passive groups, including an example of sub-slots that may be defined in accordance with various embodiments.

FIG. 5B is a dynamic sub-slot table for different ESL traffic types in active groups in accordance with various embodiments.

FIG. 5C is a dynamic sub-slot allocation table for different ESL traffic types in passive groups in accordance with various embodiments.

FIGS. 5D and 5E are dynamic sub-slot allocation and dynamic priority setting tables for different user scenarios in accordance with various embodiments.

FIG. 6 is a process flow diagram illustrating a method for optimizing performance of an ESL network sharing remote network access through the AP with a WLAN in accordance with various embodiments.

FIG. 7 is a component block diagram of an ESL suitable for use with various embodiments

FIG. 8 is a component block diagram of an access point suitable for use with various embodiments.

FIG. 9 is a component block diagram of a server suitable for use with various embodiments.

FIG. 10 is a component block diagram of a user mobile device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, various embodiments include methods, and systems implementing the methods, for balancing the performance of an ESL network and a wireless local area network (WLAN) in deployments in which both networks are supported by the same access point (AP). To enable ESL communications via a first communication protocol (e.g., Bluetooth) to coexisting with a wireless local area network (WLAN) using a second wireless communication protocol (e.g., Wi-Fi) to be supported by the same AP, a processor of the AP may implement one of a plurality of coexistence communication priority policies based on a current or in response to a change in the ESL network communication operating mode. Selecting an appropriate coexistence communication policy for communications with ESLs based on the current ESL operating mode may enable the AP to achieve a necessary communication rate with ESLs during times of large data transfers, while minimize interference with WLAN communications when communications with ESLs are infrequent. The AP may provide the selected coexistence communication priority policy to the WLAN firmware and use the coexistence communication priority policy in communications with the one or more ESLs.

Various embodiments may be implemented in a combined Bluetooth/WLAN AP to ensure that ESL traffic is protected and not unnecessarily impacted by WLAN traffic supported by the AP during operating modes characterized by large data transfers from the AP to ESLs. By prioritizing traffic on the communication protocol used for communications between the AP and ESLs, the AP is more likely to receive responses from ESLs. In addition, by sub-dividing conventional communication time slots during periods of low data traffic with ESLs, WLAN traffic supported by the AP may be provided new opportunities to communicate during previously unavailable intervals. Further, WLAN traffic may be optimized during periods in which ESL traffic is minimal. By taking advantage of available ESL network operating scenario information, various embodiments may adjust packet priorities to minimize inefficiencies of both ESL and WLAN data traffic through the same AP. In this way, the various embodiments may optimize the performance of the ESLs and devices using the WLAN in implementations in which one AP supports both ESL and WLAN data traffic.

Both ESL networks and WLAN networks use APs that transmit data packets to and receive data packets from wireless devices (e.g., ESLs or user mobile devices) and relay information to a further network, such as a management server in the ESL network and an intranet or internet in the WLAN. In some implementations, the AP transceivers and functionality may be integrated in the same AP, which may reduce costs and reduce the number of APs deployed in a facility. In some embodiments, the hardware required for both networks may be integrated in the same wireless device, with the software stack of ESL AP and WLAN AP are both running on the same device. In some embodiments, the hardware required to support one of the networks may be implemented in a dongle device coupled to the AP, such as implantations in which the ESL AP firmware is running on the dongle device that is plugged into a wireless WLAN AP device in which the WLAN AP and ESL AP host functionality are running on a processor. In such AP implementations, the ESL AP and WLAN AP firmware and functionality can communicate with each other quickly (millisecond level) using Inter Process Communication (IPC). This IPC capability in combination APs enables implementation of the coexistence mechanisms of the various embodiments.

Packet Traffic Arbitration (PTA) coexistence (sometimes referred to as “coex”) interfaces exist that act, independently or combined, for establish conditions that enable the coexistence of communications with ESLs (e.g., Bluetooth) and the WLAN (e.g., Wi-Fi) when both communications are supported by the same AP. However, some coexistence interfaces have known issues. Attempts to improve ESL performance will tend to impact WLAN performance and vise-versa.

For example, static Time Division Multiplex (TDM) traffic shaping may be implemented through the allocation of sub-slots within the ESL protocol frame structure so as to provide a fixed ratio of transmit/received time for each of the ESL and the WLAN traffic. The ESL protocol provides a natural time division by using a frame structure that repeats every 1.6 seconds that is subdivided into 128 sub-slots of 12.5 ms each. For example, a 50%:50% fixed time ratio may be achieved by allocating half of the 128 sub-slots in every ESL frame to ESL traffic, leaving the rest of the time in each frame available for WLAN traffic, thereby providing the two different types of traffic equal opportunities to transmit and/or receive data packets without mutual interferences. In this way, static TDM traffic shaping through fixed allocation of sub-slots to ESL traffic provides basic performance for both ESL and WLAN traffic. Dual ESL/WLAN AP systems may be configured to provide a static transmit/receive time ratio of ESL and WLAN through sub-slot allocations based on the scale of the ESL network and/or WLAN usage. A drawback of static allocations of sub-slots to ESL traffic (referred to herein as “static TDM”) is that data traffic sharing patterns are fixed (i.e., do not change unless reconfigured), which can result in sub-optimal behavior or even failure of communications, particularly in some operating modes of one or both networks and depending on the traffic load in either network.

Static TDM inherently confines both ESL and WLAN performances to their allocated portion of communication time; however, ESL network traffic load changes over time due to different dynamic user scenarios. Further, ESL networks may have different use-cases with different traffic profiles. For example, in a grocery store WLAN traffic may be high during the day when shoppers are using their user mobile devices 120, but at night WLAN traffic may be minimal and ESL traffic may be significant if the store management system is updating the product price and description information to be displayed the next day on ESLs. In addition, the time needed to fully support WLAN traffic may vary from 22.4% to 95%. Thus, static TDM may limit the best performance of the ESLs and/or the WLAN in various operational scenarios.

As another example of a PTA coexistence interface, a per-packet priority coexistence mechanism may be implemented that gives one packet higher priority preference over another packet with lower priority. In this way, the higher priority preference packet will “beat/stomp” the lower priority packet. However, these packet priority settings are static and thus may at times be improper. For example, although Bluetooth Low Energy (BLE) scans from ESLs should not always have the highest priority, when those ESLs are being onboarded the associated BLE scans would benefit from being assigned a higher priority. Giving ESLs being onboarded a higher priority may allow those ESLs to be discovered and onboarded as quickly as possible. In particular, when only a few out-of-sync ESLs need re-onboarding, such out-of-sync ESLs may greatly benefit from being given high priority (i.e., transmit during a time slot of the lower priority packet or network).

Quickly onboarding or re-onboarding ESLs may improve an ESL Key Performance Indicator (KPI), such as Mean Response Time (MRT). For example, MRT may be very high in response to an ESL's Extended Rate Physical (ERP) being stomped by WLAN traffic, such as the WLAN transmitting during an ESL time slot during a WLAN long burst. The AP may be unable to receive responses from ESL's if the ESL time slots are being stomped by WLAN traffic. In contrast, once a network is stable (i.e., no or few ESLs need onboarding or re-onboarding), optimizing WLAN KPIs may be more desirable to provide user mobile devices 120 greater bandwidth for accessing external networks 154.

As these examples illustrate, attempts to improve ESL KPI will tend to impact WLAN KPI and vise-versa using static coexistence communication priority policies when both network communications are supported by the same AP.

Various embodiments may dynamically select one of a number of coexistence communication priority policies adapt to different ESL/WLAN use conditions or operating modes with different traffic load conditions to improve overall performance of both ESL and WLAN communications. For example, different users may have different requirements for ESL/WLAN KPIs, and the same user may have different KPI requirements in different scenarios, operating modes, times of day, etc. Also, the scale (i.e., quantity) of ESLs in a system, and particularly those onboarding or re-onboarding may demand different communication priority requirements.

The term “electronic shelf label” or “ESL” is used herein to refer to a computing device with an electronic display that can be placed or secured to, in, on, or near store shelves. The ESL may include a processor, memory, a display, and one or more wireless transceivers, in which the processor may be programmed or provided data to render images (e.g., text, bar codes, trademarks, etc.) that communicate information (e.g., to people) regarding products near the device. In some aspects, ESLs may be battery powered to enable placement on or near products without the need for a power infrastructure. Alternatively, an ESL may be supplied power by the shelve to which the esl is secured.

ESLs may be programmed, reprogrammed or updated (e.g., via onboarding messages transmitted by the AP) so that product information rendered on the display can be updated at any time. Thus, the ESLs may serve the function of paper shelf labels with the added efficiency of enabling product information (e.g., prices) to be changed without physically replacing shelf labels.

While various embodiments are described with reference to ESLs being placed on shelves within a store, ESLs may also be positioned on large goods (e.g., furniture, appliances, etc.), on or near stands or stacks of goods, on pallets on which products are positioned, and other locations where products may be offered for sale or selection. Further, ESLs may be used for other purposes, such as placed on doors to indicate vacant or occupied status. Thus, the “S” in ESL is not intended to limit the claims to labels that are only positioned on shelves.

As used herein, the term “user” refers to a network operator or an external smart agent/module/application that has the capability of detecting and/or triggering user scenario changes.

As used herein, the term “computing device” refers to an electronic device equipped with at least a processor, memory, and a device for presenting output such as a location of an object or objects of interest. In some embodiments, a computing device may include wireless communication devices such as a transceiver and antenna configured to communicate with wireless communication networks. A computing device may include any one or all of an outer smart device, a base-band, smart watches, smart rings, smart necklaces, smart glasses, smart contact lenses, contactless sleep tracking devices, smart furniture such as a smart bed or smart sofa, smart exercise equipment, Internet of Things (IoT) devices, augmented/virtual reality devices, cellular telephones, smartphones, portable computing devices, personal or mobile multimedia players, laptop computers, tablet computers, 2-in-1 laptop/table computers, smart books, ultrabooks, multimedia Internet-enabled cellular telephones, entertainment devices (e.g., wireless gaming controllers, music and video players, satellite radios, etc.), and similar electronic devices that include a memory, wireless communication components and a programmable processor. In some embodiments, a computing device may be wearable device by a person. As used herein, the term “smart” in conjunction with a device, refers to a device that includes a processor for automatic operation, for collecting and/or processing of data, and/or may be programmed to perform all or a portion of the operations described with regard to various embodiments.

The term “mobile wireless device” is used herein to refer to computing devices that include any one or all of customer smartphones, a store picker's mobile wireless device, cellular telephones, portable computing devices, laptop computers, tablet computers, smartbooks, ultrabooks, palmtop computers, multimedia Internet-enabled cellular telephones, wearable devices including smart watches, smart clothing, smart glasses, earbuds, headphones, smart wrist bands, and similar electronic devices that include a memory, wireless communication components and a programmable processor.

The term “user mobile device” is used to refer to a mobile wireless device that is specifically configured to support users within a store, such as the store picker job functioning within a store picker system according to various embodiments. A store picker wireless device may include a processor, memory, an electronic display, wireless transceiver(s) including a Bluetooth transceiver and Wi-Fi transceiver, a barcode scanner, and other components useful for store picking.

The term “store” when used herein with reference to a physical place refers to a wholesale, retail, or other building in which products are stored for sale and/or distribution. A store may include (but is not limited to) a warehouse, fulfillment center, department store, specialty store, market, supermarket, hypermarket, convenience store, discount store, super store, and/or other storage facility.

The term “product” is used herein to refer to one or more items, articles, merchandise, or substances that are collected, refined, manufactured, and/or assembled and are maintained in a store or the like, such as products that may be identified on a shopping list and picked by store pickers.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single computing device. The proximity of the SOCs facilitates high speed communications and the sharing of memory and resources.

As described in more detail with reference to the figures, various embodiments provide systems that include a store management entity server within a store that is coupled to one or more wireless APs (e.g., Wi-Fi, Bluetooth Low Energy (BLE) access points, and/or the like) that are deployed throughout the store/warehouse and configured to establish wireless communication links (e.g., Wi-Fi or BLE) with a large number of ESLs. The ESLs may be configured to transmit and receive BLE messages, such as ESL advertisements that identify and locate the individual ESLs to the AP and/or store management entity server. In addition, the AP may also provide remote network access to a WLAN operating within the same store/warehouse.

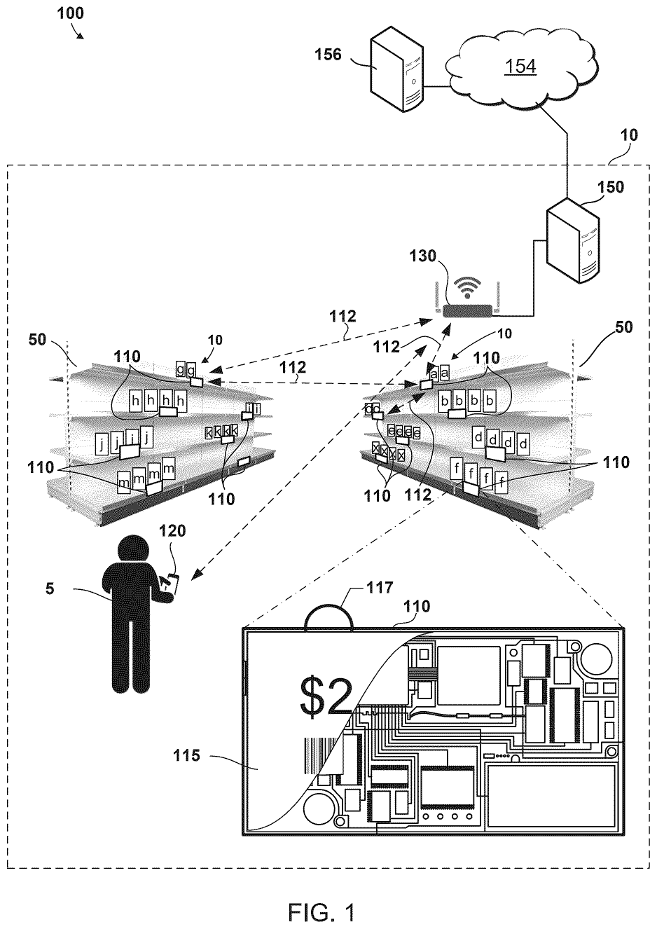

FIG. 1 is a component block diagram of a shared ESL and WLAN communication system 100 supported by a shared ESL/WLAN AP suitable for implementing various embodiments. The shared ESL and WLAN system 100 may be deployed within a given store 10 that includes one or more ESL/WLAN APs 130 supporting the WLAN (e.g., Wi-Fi network) and communicating with a plurality of ESLs 110 deployed on shelves 50 via Bluetooth communication protocols. The APs 130 may be configured to both communicate information to ESLs 110 and to relay information from ESLs 110 to a store management entity server 150, as well as receive control commands from the store management entity server 150.

ESLs 110 may be positioned on shelves 50 associated with products (labeled a, b, c, d, e, f, g, h, i, j, k, and m). Each ESL 110 may include a display 115 on which is presented product name, product codes, prices, stocking information, barcodes, and the like. In some embodiments, not every ESL will be configured and/or equipped the same or with the same capabilities. The ESLs 110 may be configured to receive communications from the store management entity server 150, such as through wireless links 112 that may be relayed via the APs 130. Thus, the store management entity server 150 may configure each ESL 110 with product information to be displayed, as well as duty cycles for when the ESL should activate to receive signals and transmit wireless beacons. The store management entity server 150 may control the periodicity of ESL duty cycles in order to minimize battery drain/usage, so as to extend the operating life, while ensuring the ESL is responsive to customers and store pickers, such as by increasing the duty cycle when individuals are within proximity of an ESL (e.g., close enough to see and/or read a display of the ESL). Further, management entity server 150 may configure ESLs 110 to generate an appropriate indication (e.g., visual, audible, and/or tactile indications) at an appropriate time, such as when an ESL is associated with a product that appears on a shopping list of a user that is nearby (e.g., within a predetermined distance). In various embodiments, the store management entity server 150 may be located within or near the store, or located remotely, such as in the Cloud, and accessed via a network, such as the Internet.

ESLs 110 may be configured to exchange wireless communications with each other through wireless links 112, such as wireless beacons or tones, for various purposes, including in particular for determining the relative and actual location of the ESLs on shelves 50 and with respect to one another as described herein.

In many implementations of ESL networks, such as stores, warehouses, and the like, a WLAN capability, such as a Wi-Fi network, may also be deployed such as to support communications with user mobile devices 120 (e.g., (e.g., smartphones, tablet computers, laptops, etc.). In some implementations, the WLAN will be supported by one or more APs that also send wireless signals (e.g., Wi-Fi packets) to and receive wireless signals from various wireless devices and provide access to internal and external networks 154, such as the Internet. For example, in addition to being personal mobile devices of users 5, mobile devices 120 that may be used in the shared ESL/WLAN system 100 may include smart watches, body cams, augmented reality glasses (e.g., smart glasses), and facility-specific or enterprise-specific handheld devices that are configured specifically for store pickers or other customers/users.

ESLs 110 may be configured to communicate with APs 130 via wireless links 112, such as Bluetooth or Bluetooth Low Energy (BLE) protocol communications. For example, ESLs 110 may transmit certain BLE signals 112, such as ESL advertisements, that are configured to be received by a nearby AP 130 and used to onboard the ESL 110. BLE signals 112 may be broadcast at a set or select power level, enabling separation distances to be estimated based upon the measured received signal strength indicator (RSSI) of the signals received by other ESLs 110. APs 130 may be coupled to the store management entity server 150 via wired connections.

The WLAN access points 130 may provide user mobile devices 120 with access to external networks 154, such as the Internet to enable customers to access remote servers 156, such as to comparison shop, research products, and otherwise provide Internet access support.

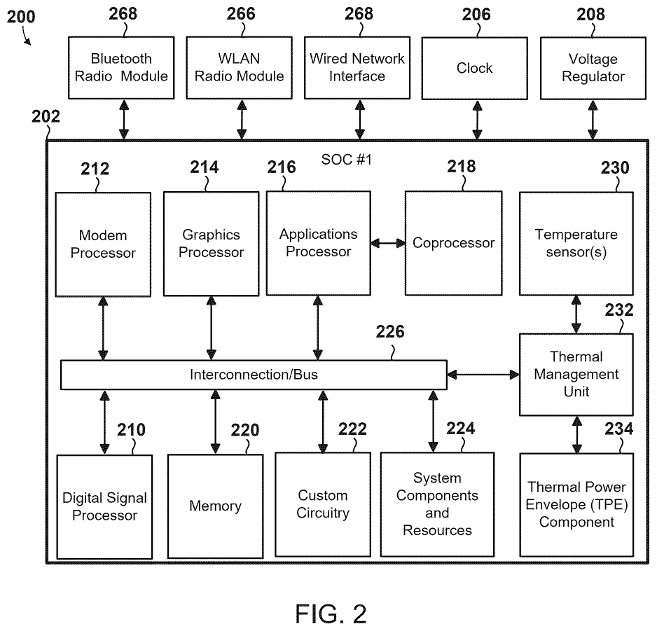

FIG. 2 is a component block diagram illustrating a non-limiting example of a computing and wireless modem system 200 in a computing device suitable for implementing any of the various embodiments. Various embodiments may be implemented on a number of single processor and multiprocessor computer systems, including a system-on-chip (SOC) or system in a package (SIP).

With reference to FIGS. 1-2, the illustrated example computing system 200 (which may be a SIP in some embodiments) includes an SOC 202 coupled to a clock 206, a voltage regulator 208, a WLAN radio module 266 configured to send and receive wireless communications, such as Wi-Fi packets, via an antenna (not shown), a Bluetooth radio module 268 configured to send and receive wireless communications, including BLE messages, via an antenna (not shown), and wired network interface 268 configured to communicate with wired networks (e.g., ethernets). When the computing system 200 is used in ESL/WLAN APs, the Bluetooth radio module 268 may be configured to broadcast BLE beacons as described herein. In some implementations, the SOC 202 may operate as central processing unit (CPU) of the user mobile device that carries out the instructions of software application programs by performing the arithmetic, logical, control and input/output (I/O) operations specified by the instructions.

The SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The SOC 202 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the SOC 202 may include power amplifiers, voltage regulators, oscillators, phase-locked loops, peripheral bridges, data controllers, memory controllers, system controllers, access ports, timers, and other similar components used to support the processors and software clients running on a user mobile device. The system components and resources 224 or custom circuitry 222 also may include circuitry to interface with peripheral devices, such as cameras, electronic displays, wireless communication devices, external memory chips, etc.

The various processors 210, 212, 214, 216, 218 may be interconnected to one or more memory elements 220, system components and resources 224, and custom circuitry 222, and a thermal management unit 232 via an interconnection/bus module 226. The interconnection/bus module 226 may include an array of reconfigurable logic gates or implement a bus architecture (such as CoreConnect, AMBA, etc.). Communications may be provided by advanced interconnects, such as high-performance networks-on chip (NoCs).

The SOC 202 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

Various embodiments may optimize performance of an ESL network sharing remote network access through the AP with a WLAN. A processor of the AP may consider user scenario changes, deployed system parameters, and particular network traffic conditions in order to dynamically change a coexistence communication priority policy for transmissions from the WLAN and one or more ESLs in an ESL network. In particular, the processor of the AP may use scenario-based dynamic priority adjustment, priority arbitration per sub-slot, and/or dynamic scalable sub-slot allocations to achieve TDM traffic shaping.

In various embodiments, the processor of the AP may be configured to implement changes to coexistence communication priority policies in response to detecting a change in an ESL network communication operating mode. Each of the ESL network communication operating modes may be associated with common or at least anticipated user scenarios that may benefit from a customized coexistence communication priority policy. By using predefined types of ESL user scenarios that are detectable by the processor or for which the processor is otherwise notified (e.g., user triggered scenario change), the processor may change priority settings for different types of communication traffic.

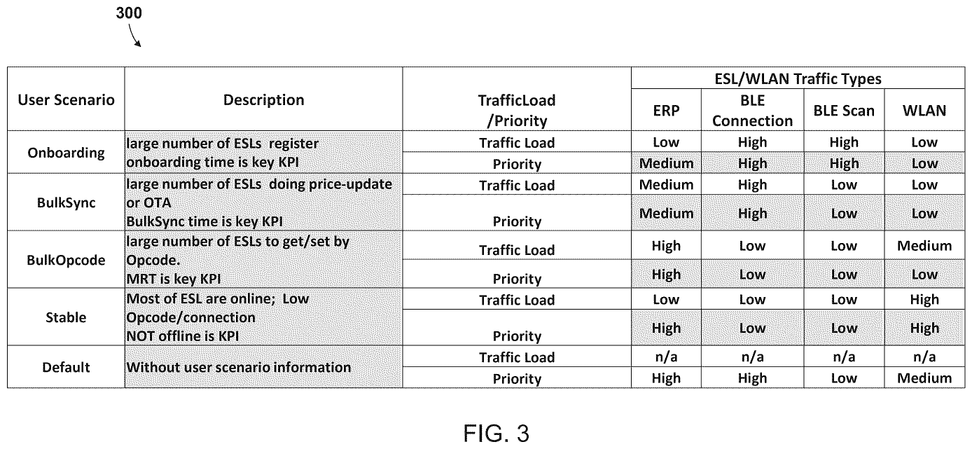

FIG. 3 illustrates a dynamic ESL user scenario configuration table 300, that includes customized coexistence communication priority policies suitable for use in various embodiments. With reference to FIGS. 1-3, a processor of the AP (e.g., 130) may maintain the dynamic ESL user scenario configuration table 300 as a look-up table or database that provides predetermined coexistence communication priority policies for different user scenarios. For example, four basic user scenarios that may be used in this regard include 1) onboarding; 2) bulk synchronization (i.e., “BulkSync”); 3) bulk operating code setting/updating (i.e., “BulkOpcode”); or 4) a stable network (i.e., “Stable”). Additionally, the dynamic ESL user scenario configuration table 300 may include a default user scenario, which may act as a catch-all when conditions do not match any of the four predetermined scenarios. The default scenario may be considered a fifth scenario, along with the other above-noted four scenarios. Optionally, additional scenarios may be included in the dynamic ESL user scenario configuration table 300 and considered by the processor as further alternative user scenarios along with their own predetermined coexistence communication priority policies. In various embodiments, the processor may access the dynamic ESL user scenario configuration table 300 in order to determine which coexistence communication priority policy should be implemented based on a current user scenario.

The dynamic ESL user scenario configuration table 300 may designate priority levels for the four basic ESL/WLAN traffic types. Namely, ERP, BLE Connection, BLE Scan, and WLAN traffic. In addition to the priority level given to each type of traffic, the dynamic ESL user scenario configuration table 300 indicates a traffic load level associated with each type of traffic to illustrate the conditions that tend to be present during each user scenario.

The “Onboarding” user scenario includes circumstances in which a large number of ESLs are registered and/or made a part of the shared ESL-AP and WLAN system (e.g., 100). The time an ESL takes to onboard may be a leading KPI indicator of performance. Thus, during the Onboarding user scenario, the BLE Connection and BLE Scan traffic, which will each be high, are given the highest priority in order to maximize performance of the ESLs during that period. In contrast, the low level of ERP traffic may be assigned a medium priority, while the low level of the WLAN traffic may be assigned a low priority.

The “BulkSync” user scenario includes circumstances in which a large number of ESLs are being updated, such as for price updates made over-the-air (OTA). The time an ESL takes to complete bulk synchronizations may be a leading KPI indicator of performance. Thus, during the Bulk Sync user scenario, the BLE Connection traffic, which will be high, may be given the highest priority in order to maximize performance of the ESLs during that period. In contrast, the medium level of ERP traffic may be assigned a medium priority, the low level of the BLE Scan traffic may be assigned a low priority, and the low level of the WLAN traffic may be assigned a low priority.

The “BulkOpcode” user scenario includes circumstances in which a large number of ESLs are being reset or receiving operating code updates. The MRT for the ERP may be a leading KPI indicator of performance. Thus, during the BulkOpcode user scenario, the ERP traffic, which will be high, may be given the highest priority during that period. In contrast, the low level of BLE Connection and BLE Scan traffic may be assigned a low priority, while the medium level of the WLAN traffic may also be assigned a low priority.

The “Stable” user scenario includes circumstances in which most ESLs are online and do not require operating code or other updates. KPI is only measured when the ESLs are online. Thus, during the Stable user scenario, the ERP, which will be low, may be given high priority during that period. In contrast, the BLE Connection and BLE Scan traffic, which will be low, may be given the lowest priority during that period. Notably, the generally high level of the WLAN traffic may be assigned a high priority.

The “Default” user scenario may be the catch-all for circumstances not considered by any of the other user scenarios or without any particular user scenario information associated there with. During the Default user scenario, the traffic levels for ERP, BLE Connection, BLE Scan, and WLAN may vary and are thus not defined (i.e., “n/a”). Nonetheless, as a default the ERP and the BLE Connection traffic may be given the highest priority. Notably, the BLE Scan traffic may be given a low priority and the WLAN traffic may be assigned a medium priority.

Communications using Bluetooth Asynchronous Connection-Less (ACL) transport may make use of time slots defined by the underlying physical channel. A time slot is generally considered a basic unit of timing for a protocol. Often a time slot is equal to a transmit/receive turn-around time, channel sensing time, propagation delay, and processing time. For example, the time slots may define 12.5 ms intervals for the transmission (Tx) and/or reception (Rx) of data. A pattern of Tx and Rx may be established and repeated by an AP. Also, an ESL may be assigned to listen for a Tx along with a select group of other ESLs, so that different groups may listen during different time slots (i.e., each group may be assigned a time slot). In this way, since ESL profile specifications may include 128 groups, each ESL may listen at least every 1.6 seconds.

The 128 groups in the ESL profile specifications may be divided into several types. For example, active groups may include those with at least one ESL tag being onboarded. Passive groups may include those without any ESLs and may be assigned to other Radio Frequency (RF) radios, such as WLAN. The time slots allocated to transmissions to/from Active and Passive groups may be altered to cater to different scales of ESL networks and/or different KPI requirements. For example, Active: Passive ratios may be configured to allocate the transmit/receive slots and sub-slots accordingly, such as ratios 2:2, 1:3, etc. However, alterations to ESL protocol transmit/receive slots and sub-slots are not typically performed often, since otherwise the ESLs would need to be informed to either look for Periodic Advertisement (PA) messages on alternative slots or for the active/passive change to never exceed a threshold of 6 consecutive loss packets for an ESL. Alternatively, the threshold of 6 consecutive loss packets for an ESL could be significantly increased (e.g., dynamically) under appropriate circumstances in order to accommodate such alterations to slot and sub-slot allocations within the ESL protocol frame structure.

Various embodiments may take advantage of vacant gaps in active group time slots in order to improve both ESL and WLAN performance. In particular, unlike ESLs, the WLAN may have a generally longer time interval to send traffic in passive groups, but the WLAN is typically configured to not send traffic in vacant gaps within active groups. WLAN is configured to not send traffic within active groups to avoid transmitting during an ESL time slot, and thus avoid stomping ESL traffic. Thus, a bitmap identifying active and passive groups may be transmitted to a WLAN module for WLAN traffic shaping (i.e., avoiding conflicts with ESL traffic).

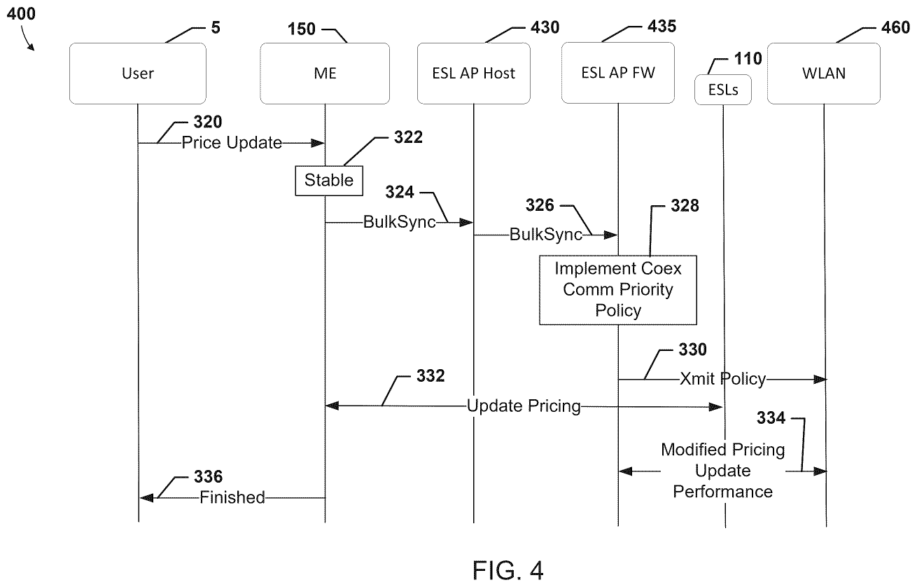

FIG. 4 is a communication flow diagram illustrating an example method 400 for optimizing performance of an ESL network sharing remote network access through the AP with a wireless local area network WLAN. With reference to FIGS. 1-4, the method 400 shows an example of a dynamic ESL user scenario that involves a bulk ESL price update being deployed to select ESLs.

The method 400 may be initiated by a user 5 on behalf of the ME 150 or other managing agent of the ESL network. The user 5, using a computing device (e.g., 120) may transmit a Price Update 320 to the ME 150. Prior to initiating a BulkSync with the price update to multiple ESL, the ME 150 may determine whether the ESL network is stable 322 and ready for such a procedure. The ME 150 may then transmit a BulkSync message 324 to the ESL AP Host 430, which may in-turn transmit a BulkSync message 326 to the ESL AP firmware (FW) 435.

The ESL AP FW 435 determine whether a change has occurred in the ESL network communication operating mode in response to receiving the BulkSync message 326 from the ESL AP Host 430. Since the BulkSync message 326 indicates a change in the ESL network communication operating mode should occurred, the ESL AP FW 435 may initiate a switch to a different user scenario in order to implement an appropriate coexistence communication priority policy (i.e., Implement Coexistence Comm Priority Policy”). For example, the ESL AP FW 435 may use the dynamic ESL user scenario configuration table (e.g., 300) or a similar database to determine the appropriate policies that apply to a BulkSync user scenario. In particular, for a BulkSync the BLE connection may be given a highest priority, which allows the ESL traffic to transmit during a WLAN transmit/receive time slot and thus stomp WLAN traffic (if needed). In addition, the ESL AP FW 435 may provide a policy update (i.e., “Xmit Policy”) to the WLAN 460. In some embodiments, the policy update may be provided to a scheduler/controller within the WLAN radio portion of the AP. In some embodiments, the policy update may be provided to a packet traffic arbitrator (PTA), which may be a hardware protocol implemented within the AP to arbitrate sharing of antennas by the ESL AP Host 430 and the WLAN 460 (i.e., to prevent simultaneous transmissions or transmissions by one when the other needs to receive incoming packets or messages).

In addition, the ME 150 may transmit a Update Pricing message 332 to appropriate ESL and receive acknowledgements therefrom. During this period, the WLAN 460 traffic may experience modified pricing update performance 334. This may occur because some ESLs have been given priority over WLAN while the BulkSync process is taking place.

Upon the completion of the BulkSync process, the ME 150 may notify the user 5 that the price update is complete by transmitting a Finished message 336. In addition, the ME 150 may automatically check the status of the ESL network and initiate a new coexistence communication priority policy to revert to the previous ESL network communication operating mode or another mode, if appropriate.

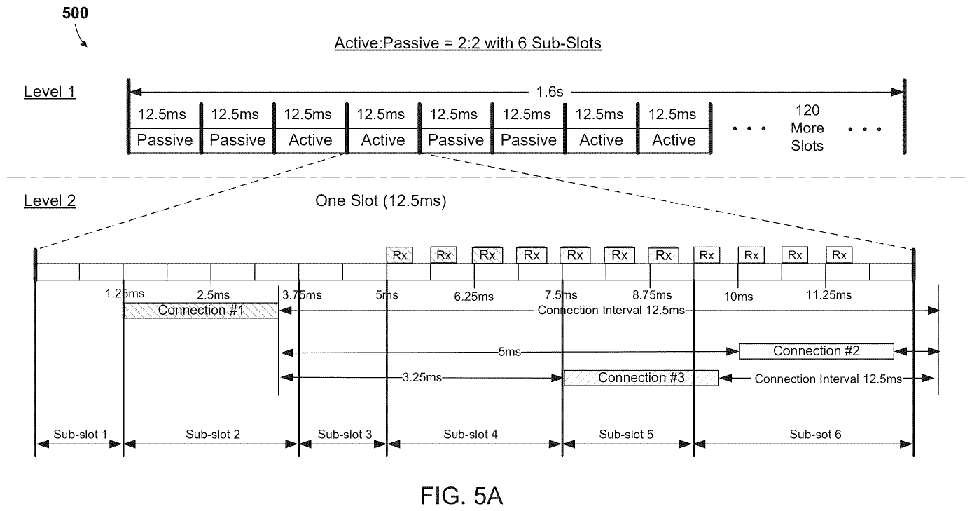

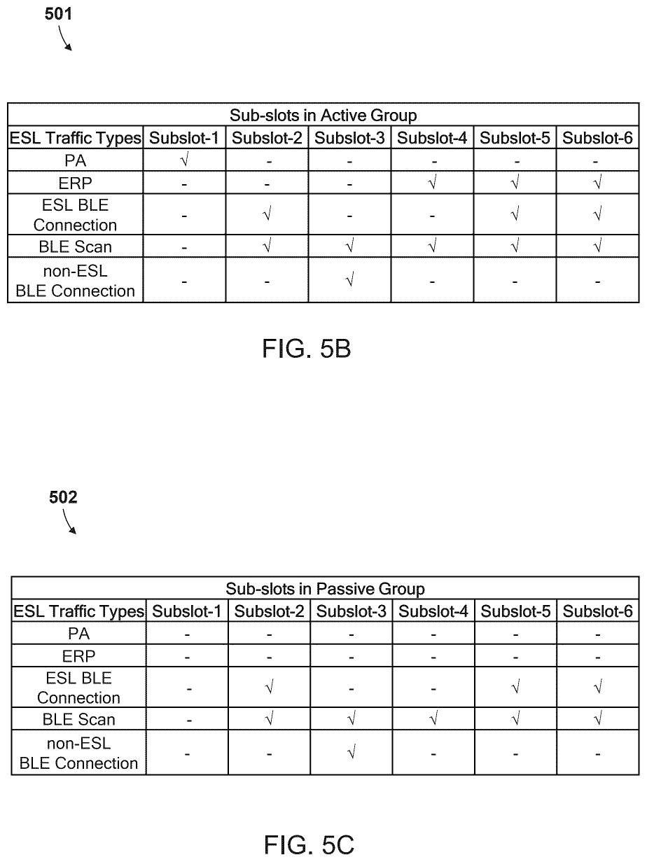

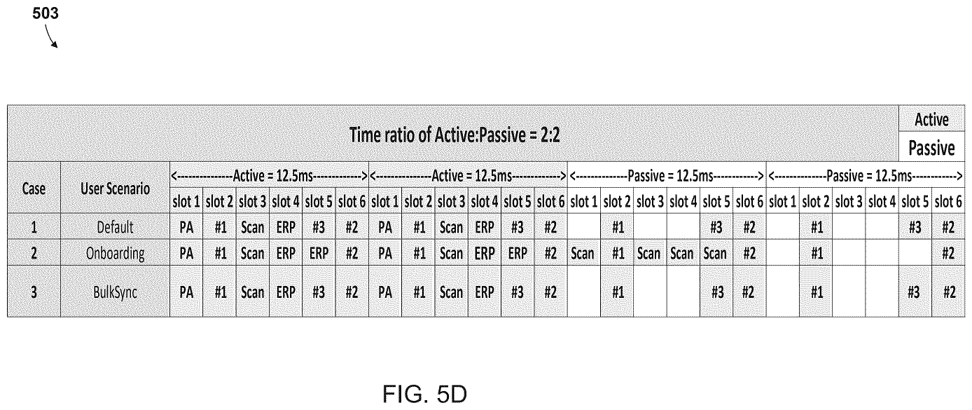

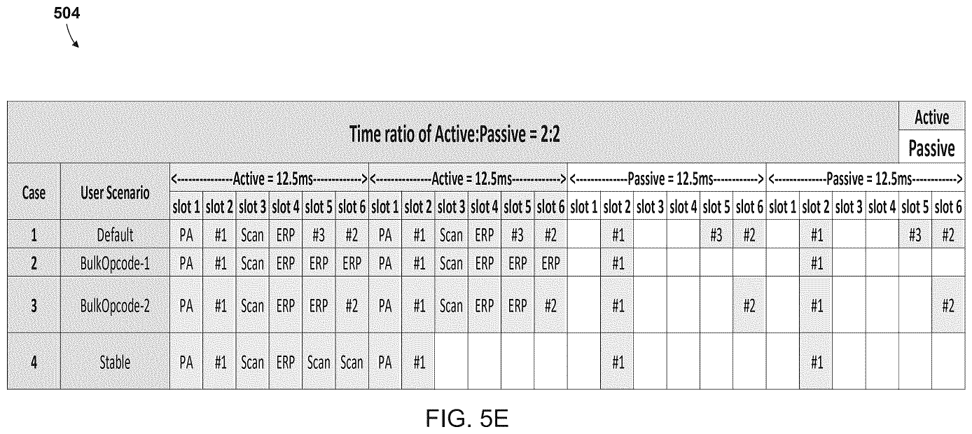

FIG. 5A shows a graph 500 of an ESL traffic pattern of active and passive groups, including an example of sub-slots that may be allocated to ESL or WLAN data traffic in accordance with various embodiments. With reference to FIGS. 1-5A, an Active:Passive ratio of 2:2 is illustrated at the time-slot level (i.e., Level 1) that includes two consecutive passive time slots followed by two consecutive active time slots, which pattern may repeat itself indefinitely. In addition, a sub-slot level (i.e., Level 2) is also illustrated that includes six (6) sub-slots (i.e., Sub-slot 1, Sub-slot 2, Sub-slot 3, Sub-slot 4, Sub-slot 5, Sub-slot 6) within each group. Although the sub-slots are illustrated as being in an active time slot, sub-slots may be defined in passive slots as well.

In each sub-slot, at a specific time, one type of traffic may be assigned (i.e., tagged) a specific priority. For example, a first connection (i.e., Connection #1) may be made in Sub-slot 2; a second connection (i.e., Connection #2) may be made in Sub-slot 6; and a third connection (i.e., Connection #3) may be made in Sub-slot 5.

The first, second, and third connections (#1, #2, #3) may be designed exclusively for ESL BLE connections. In this way, given a proper priority setting, WLAN and/or ESL can dynamically occupy some sub-slots of each other's group, in order to fulfill expected KPI requirements.

FIG. 5B shows a dynamic sub-slot table 501 for different ESL traffic types in active groups in accordance with various embodiments. With reference to FIGS. 1-5B, the dynamic sub-slot table 501 shows how five different types of ESL traffic may be scheduled to use particular sub-slots within an active group. In the dynamic sub-slot table 501 a check mark represents a type of ESL traffic scheduled in a particular sub-slot, while a dash mark represents a type of ESL traffic not permitted in that sub-slot. As shown, sub-slot 1 may be allocated to PAs. Sub-slot 2 may be allocated to an ESL BLE connection or a BLE scan. Sub-slot 3 may be allocated to a BLE scan or a non-ESL BLE connection. Sub-slot 4 may be allocated to ERP or a BLE Scan. Sub-slots 5 and 6 may each be allocated to ERP, an ESL BLE connection, or a BLE scan. It should be noted that Sub-slot 3 allows non-ESL BLE connections, like WLAN traffic, in the active group.

FIG. 5C shows a dynamic sub-slot allocation table 502 for different ESL traffic types in passive groups in accordance with various embodiments. With reference to FIGS. 1-5C, the dynamic sub-slot table 502 shows how the five different types of ESL traffic may be scheduled to use particular sub-slots within a passive group. In the dynamic sub-slot table 502 a check mark represents a type of ESL traffic scheduled in a particular sub-slot, while a dash mark represents a type of ESL traffic not permitted in that sub-slot. As shown, sub-slot 1 may remain open. Sub-slot 2 may be allocated to an ESL BLE connection or a BLE scan. Sub-slot 3 may be allocated to a BLE scan or a non-ESL BLE connection. Sub-slot 4 may be allocated to a BLE Scan. Sub-slot 5 may be allocated to an ESL BLE connection or a BLE Scan. Sub-slot 6 may be allocated to an ESL BLE connection or a BLE scan.

It should be noted that, as in the active group, Sub-slot 3 in the passive group allows non-ESL BLE connections, like WLAN traffic, in the active group.

Also, notable is that PA and ERP are only valid in the active group (i.e., not allocated to the passive group), Further, the ESL BLE connection and BLE scan may also be extended in the passive group.

FIGS. 5D and 5E show dynamic sub-slot allocation and dynamic priority setting tables 503, 504 for different user scenarios in accordance with various embodiments. With reference to FIGS. 1-5E, a processor of the AP (e.g., 130) may maintain the dynamic sub-slot allocation and dynamic priority setting tables 503, 504 as a look-up table or database that provides predetermined coexistence communication priority policies for different user scenarios. The dynamic sub-slot allocation and dynamic priority setting tables 503, 504 may be combined as a single table or database or divided into more than two tables or databases.

FIG. 5D includes three user scenarios that may be used in this regard include 1) default; 2) onboarding; and 3) bulk synchronization (i.e., “BulkSync”), which scenarios were described above with regard to FIG. 3. In FIG. 5D, the dynamic sub-slot allocation and dynamic priority setting table 503 uses an Active:Passive ratio of 2:2 and thus illustrates four consecutive time slots (i.e., two active and two passive) including the division of each time slot into six sub-slots.

In the ‘Default’ user scenario, active slots may use a priority sequence of Connection>Scan>ERP>Connection. Up to three connections (#1, #2, #3) may be provided to allow ESL traffic to stomp WLAN traffic, particularly in the passive slots. In the active time slots, following the PA in sub-slot 1, in sub-slot 2 the first connection (i.e., #1) may be given priority; in sub-slot 3, a BLE Scan (i.e., Scan) may be given priority; in sub-slot 4, an ESL response (i.e., ERP) may be given priority; in sub-slot 5, connection #3 (i.e., #3) may be given priority; and in sub-slot 6, connection #2 (i.e., #2) may be given priority. Similarly, in the passive time slots, ESL traffic may stomp WLAN traffic using the three connections (#1, #2, #3). Namely, in sub-slot 2 the first connection (i.e., #1) may be given priority; in sub-slot 5, connection #3 (i.e., #3) may be given priority; and in sub-slot 6, connection #2 (i.e., #2) may be given priority.

In the ‘Onboarding’ user scenario, active slots may use a priority sequence of Connection>Scan>ERP>WLAN. In the Onboarding user scenario only two connections (#1, #2) may be provided. In addition, since the ESL traffic may be heavy during onboarding, BLE Scans can stomp some of sub-slots in the Passive group. In the active time slots of the Onboarding user scenario, following the PA in sub-slot 1, in sub-slot 2 the first connection (i.e., #1) may be given priority; in sub-slot 3, a BLE Scan (i.e., Scan) may be given priority; in sub-slot 4, an ESL response (i.e., ERP) may be given priority; in sub-slot 5, the ERP may be again given priority; and in sub-slot 6, connection #2 (i.e., #2) may be given priority. Similarly, in the passive time slots, ESL traffic may stomp WLAN traffic using the two connections (#1, #2). Namely, in sub-slot 2 the first connection (i.e., #1) may be given priority; in sub-slot 5, connection #3 (i.e., #3) may be given priority; and in sub-slot 6, connection #2 (i.e., #2) may be given priority. In addition, in half the passive time slots, a BLE scan (i.e., Scan) may be given priority. Namely, in sub-slot 1, 3, 4, and 5.

In ‘BulkSync’ user scenario, active slots may use a priority sequence of Connection>Scan>ERP/WLAN. Once again, up to three connections (#1, #2, #3) may be provided to allow ESL traffic to stomp WLAN traffic, particularly in the passive slots. In the active time slots, following the PA in sub-slot 1, in sub-slot 2 the first connection (i.e., #1) may be given priority; in sub-slot 3, a BLE Scan (i.e., Scan) may be given priority; in sub-slot 4, an ERP may be given priority; in sub-slot 5, connection #3 (i.e., #3) may be given priority; and in sub-slot 6, connection #2 (i.e., #2) may be given priority. Similarly, in the passive time slots, ESL traffic may stomp WLAN traffic using the three connections (#1, #2, #3). Namely, in sub-slot 2 the first connection (i.e., #1) may be given priority; in sub-slot 5, connection #3 (i.e., #3) may be given priority; and in sub-slot 6, connection #2 (i.e., #2) may be given priority. In contrast to the Onboarding user scenario, in the BulkSync user scenario the BLE Scan is not allowed to stomp WLAN in the passive group.

FIG. 5E includes four user scenarios that may be used in this regard, including 1) default; 2) BulkOpcode-1; 3) BulkOpcode-2; and 4) stable, which scenarios were described above with regard to FIG. 3. In FIG. 5E, the dynamic sub-slot allocation and dynamic priority setting table 504 uses Active:Passive ratio of 2:2 for ease of explanation and as a comparison to the traffic pattern priorities in FIG. 5D. The “Default′ user scenario is the same as that described above with regard to FIG. 5D. Two different BulkOpcode user scenarios are provided as examples.

Additional BulkOpcode user scenarios may be included, if needed or desired. In both illustrative ‘BulkOpcode-1’ and ‘BulkOpcode-2’ scenarios, active slots may use a priority sequence of ERP >Scan/Connection/WLAN. In BulkOpcode-1, ERP may be satisfied first by providing as much time as possible in sub-slots 4-6, but this limits the active and passive sub-slots to only one connection (#1). In contrast, the BulkOpcode-2 user scenario, extra time is assigned to ERP, but just not as much as BulkOpcode-1. In particular, the BulkOpcode-2 user scenario assigns only sub-slots 4 and 5 to ERP, while making room for a second connection (#2), in addition to maintaining the first connection (#1) for both active and passive groups. In both BulkOpcode user scenarios, BLE scans are not configured to stomp WLAN in the passive group.

In ‘Stable’ user scenario, some active slots may use a priority sequence of WLAN >ERP/Scan/Connection. WLAN can stomp continuous sub-slots in Active group to get best performance. Also, only 1 connection needs to be maintained for stomping WLAN in the passive group. BLE Scans are not configured to stomp WLAN in the passive group. Also, the Stable user scenario may accommodate ERP in only one sub-slot, namely sub-slot 3.

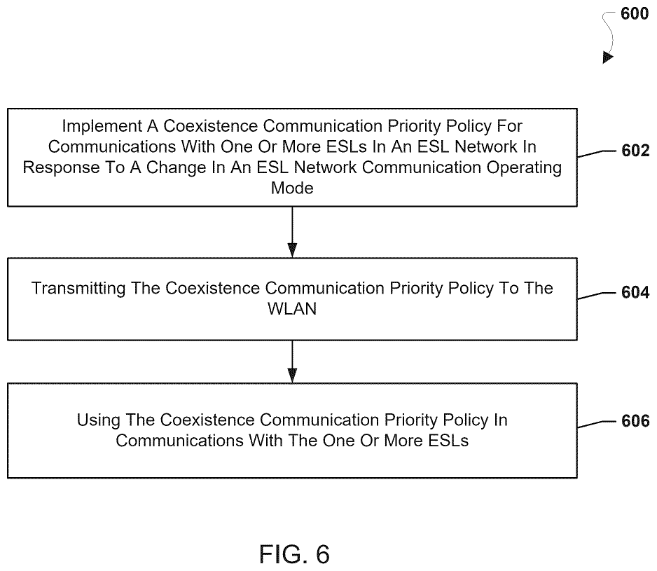

FIG. 6 is a process flow diagram illustrating a method 600 for optimizing performance of an ESL network (e.g., 100) sharing remote network access through a dual-network ESL/WLAN AP (e.g., 130) with a WLAN, in accordance with various embodiments. With reference to FIGS. 1-6, means for performing each of the operations of the method 600 may be performed by a processor (e.g., 202 210, 212, 214, 216, 218, 802, and/or 804), a first transceiver (e.g., 268, 816), which may be a Bluetooth subsystem and wireless transceiver, and a second transceiver (e.g., 266, 817), which may be a WLAN wireless transceiver (e.g., Wi-Fi transceiver), of an ESL/WLAN AP (e.g., 130). Alternatively, the means for performing each of the operations of the method 600 may be a processor (e.g., 210, 212, 214, 216, 218 and/or 901) and/or a transceiver (e.g., 907) of a store management entity server (e.g., 150) and the like. As a further alternative, means for performing each of the operations of the method 600 may be a processor of the AP and store management entity server or other computing device working in combination.

In block 602, the processor of the AP may implement a coexistence communication priority policy for transmissions from the WLAN and one or more ESLs in the ESL network in response to a change in an ESL network communication operating mode. Implementing the coexistence communication priority policy may alter allocations of sub-slots within a frame structure of the ESL protocol to adjust the ratio of time available for packet transmissions in the WLAN and transmissions to and from the one or more ESLs in the ESL network.

In some embodiments, the coexistence communication priority policy may be selected from predefined sets of coexistence communication priority policies. Also, each of the sets of coexistence communication priority policies may be customized for different ESL network communication scenarios. Each set of coexistence communication priority policies may define a priority level based on traffic load for different types of traffic between the WLAN and one or more ESLs in the ESL network. The coexistence communication priority policy may be configured to enable traffic from both the WLAN and the one or more ESLs during different sub-slots of the same frame structure, and thus to coexist by avoiding transmissions by the AP for both networks at the same time and avoiding transmissions by the AP for one network at a time when the AP needs to listen for packets or messages from the other network. In some aspects, the coexistence communication priority policy may be configured to enable an ESL to stomp a WLAN sub-slot. In some aspects, the coexistence communication priority policy is configured to enable the WLAN to stomp an ESL sub-slot. In some aspects, the coexistence communication priority policy may define at least one dedicated sub-slot within at least one of an active group or a passive group of time slots for ESL communications.

In some embodiments, implementing the coexistence communication priority policy may include at least one of dynamic sub-slot division and dynamic priority setting. In some embodiments, the change in the ESL network communication operating mode may be to a scenario selected from onboarding of ESLs, synchronization of ESLs, ESL operating code updates or setup, most of the one or more ESLs being stable, or a default user scenario.

In block 604, a transmitter of the AP may provide the coexistence communication priority policy to the WLAN. In some embodiments, the policy update may be provided to a scheduler/controller within the WLAN radio portion of the AP. In some embodiments, the policy update may be provided to a PTA implemented within the AP that arbitrates sharing of antennas according to the coexistence communication priority policy.

In block 606, the processor of the AP (e.g., 130), may using the coexistence communication priority policy in communications with the one or more ESLs. For example, the used coexistence communication priority policy may follow the parameters included in the dynamic ESL user scenario configuration table 300, the dynamic sub-slot tables 501, 502, or the dynamic sub-slot division and dynamic priority setting tables 503, 504.

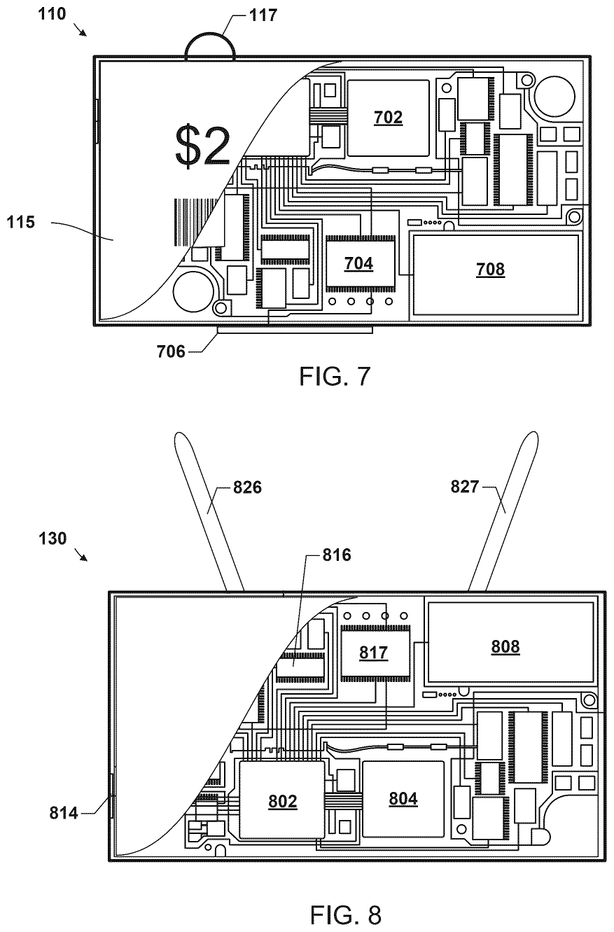

FIG. 7 is a component block diagram of an example of an ESL 110 suitable for use with various embodiments. With reference to FIGS. 1-7, an ESL 110 may include a display 115 and an light emitting diode (LED) 117 (or other type of visible indicator) that our coupled to a processor 702 that is configured with processor-executable instructions configured to cause the processor to perform operations of various embodiments. The processor 702 may be coupled to a wireless transceiver 704, such as a BLE transceiver or a combination BLE and Wi-Fi transceiver, that is coupled to an antenna 706 for sending and receiving RF signals as described herein. In various embodiments, the processor 702 may include an SOC (e.g., 202). An ESL 110 may be powered by a battery 708, freeing the display from having to be connected to a wired power supply. Alternatively, the ESL 110 may be powered from an external source.

FIG. 8 is a component block diagram of a dual-network AP 130 suitable for use with various embodiments. With reference to FIGS. 1-8, the AP 130 may typically include a processor 802, 804 coupled to volatile and/or nonvolatile memory 808. The AP 130 may include a first transceiver 816 coupled to an antenna 816 and configured to communicate via wireless signals with ESLs, such as a Bluetooth subsystem and radio. The AP 130 may also include a second transceiver 817 coupled to an antenna 827 and configured to communicate via wireless signals with a WLAN, such as a Wi-Fi transceiver and firmware. So configured, a dual-network AP 130 according to various embodiments may support communications with both an ESL network (e.g., acting as a Bluetooth AP) and a WLAN (e.g., acting as a Wi-Fi AP). The AP 130 may also include a peripheral memory access device, such as a flash drive, coupled to the processor 802, 804. The AP 130 may also include network access ports 814 (or interfaces) coupled to the processor 802, 804 for establishing data connections with a network, such as the Internet and/or a local area network coupled to other system computers and servers. The AP 130 may include additional access ports, such as USB, Firewire, Thunderbolt, and the like for coupling to peripherals, external memory, or other devices.

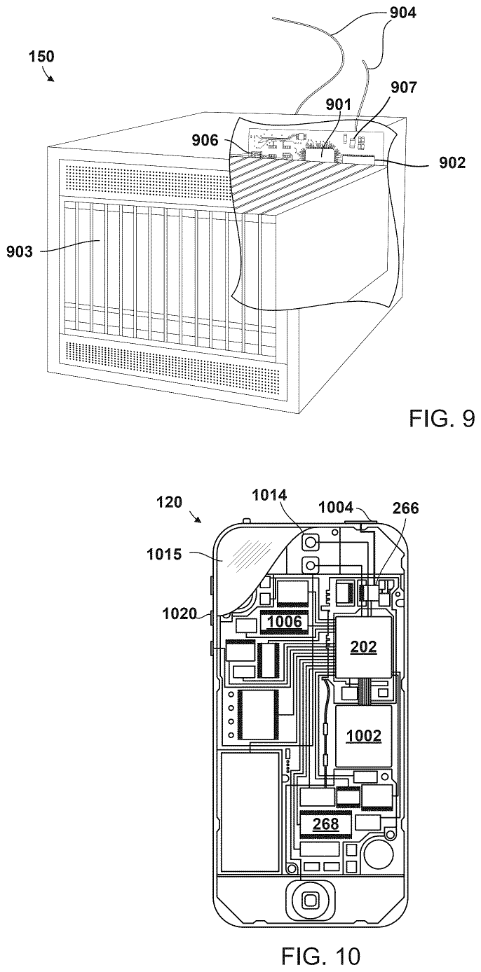

FIG. 9 is a component block diagram of a store management entity server 150 suitable for use with various embodiments. With reference to FIGS. 1-9, the store management entity server 150 may typically include a processor 901 coupled to volatile memory 902 and a large capacity nonvolatile memory, such as a disk drive 903. The store management entity server 150 may also include a peripheral memory access device, such as a floppy disc drive, compact disc (CD) or digital video disc (DVD) drive 906 coupled to the processor 901. The store management entity server 150 may also include network access ports 904 (or interfaces) coupled to the processor 901 for establishing data connections with a network, such as the Internet and/or a local area network coupled to other system computers and servers. The store management entity server 150 may include one or more antennas 907 for sending and receiving electromagnetic radiation that may be connected to a wireless communication link. The store management entity server 150 may include additional access ports, such as USB, Firewire, Thunderbolt, and the like for coupling to peripherals, external memory, or other devices.

FIG. 10 is a component block diagram of a user mobile device 120 suitable for use as a user mobile device or a consumer user equipment (UE) when configured with processor executable instructions to perform operations of various embodiments. With reference to FIGS. 1-10, the user mobile device 120 may include a first SOC 202 (e.g., a SOC-CPU) coupled to a second SOC 1002 (e.g., a 5G capable SOC). The first and second SOCs 202, 1002 may be coupled to internal memory 1006, a display 1015, and to a speaker 1014. Additionally, the user mobile device 120 may include an antenna 1004 for sending and receiving electromagnetic radiation that may be connected to a radio module 266 configured to support wireless local area network data links (e.g., BLE, Wi-Fi, etc.) and/or wireless wide area networks (e.g., cellular telephone networks) coupled to one or more processors in the first and/or second SOCs 202, 1002. The user mobile device 120 typically also include menu selection buttons 1020 for receiving user inputs.

A typical user mobile device 120 may also include an inertial measurement unit (IMU) 268 that includes a number of micro-electromechanical sensor (MEMS) elements configured to sense accelerations and rotations associated movements of the device, and provide such movement information to the first SOC 202. Also, one or more of the processors in the first and second SOCs 202, 1002, radio module 266 may include a digital signal processor (DSP) circuit (not shown separately).

In some embodiments, a user mobile device 120 may be used as a moving AP to diagnose ESLs that have issues establishing communication with the APs or other fixed infrastructure. For example, the user mobile device 120 may be repurposed by the store management entity server by configuring the user mobile device 120 with AP protocols so that the user mobile device 120 may be recognized by ESL as an AP.

The processors of ESLs 110, the user mobile device 120, and the store management entity server (e.g., 150) may be any programmable microprocessor, microcomputer or multiple processor chip or chips that can be configured by software instructions (applications) to perform a variety of functions, including the functions of the various embodiments described below. In some user mobile devices, multiple processors may be provided, such as one processor within an SOC 1002 dedicated to wireless communication functions and one processor within an SOC 202 dedicated to running other applications. Typically, software applications may be stored in the memory 1006 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 600 may be substituted for or combined with one or more operations of the method 600.

Implementation examples are described in the following paragraphs. While some of the following implementation examples are described in terms of example methods, further example implementations may include: the example methods discussed in the following paragraphs implemented by an AP including a processor configured to perform operations of the example methods; the example methods discussed in the following paragraphs implemented by an AP including means for performing functions of the example methods; the example methods discussed in the following paragraphs implemented in a processor used in an AP that is configured to perform the operations of the example methods; and the example methods discussed in the following paragraphs implemented as a non-transitory processor-readable storage medium having stored thereon processor-executable instructions configured to cause a processor of an AP to perform the operations of the example methods.

Example 1. A method, performed by a processor of an access point (AP), for managing communications of an electronic shelf label (ESL) network and a wireless local area network (WLAN) supported by the AP, including: implementing a coexistence communication priority policy for communications with ESLs and the WLAN in response to a change in an ESL network operating mode; sharing the coexistence communication priority policy with WLAN firmware of the AP; and using the coexistence communication priority policy in communications with ESLs.

Example 2. The method of example 1, in which implementing the coexistence communication priority policy alters allocations of sub-slots within a frame structure of an ESL protocol to adjust a ratio of time available for packet transmissions in the WLAN and transmissions to and from ESLs.

Example 3. The method of either of example 1 or example 2, further comprising selecting the coexistence communication priority policy from predefined sets of coexistence communication priority policies stored in the AP, in which each of the sets of coexistence communication priority policies is customized for different ESL network communication scenarios.

Example 4. The method of example 3, in which each set of coexistence communication priority policies defines a priority level of WLAN or ESL communications based on traffic loads for different types of traffic between the WLAN and ESLs.

Example 5. The method of any of examples 1-4, in which the coexistence communication priority policy is configured to enable an ESL to transmit during a WLAN packet transmission or reception time.

Example 6. The method of any of examples 1-5, in which the coexistence communication priority policy is configured to enable the WLAN to transmit during an ESL sub-slot.

Example 7. The method of any of examples 1-6, in which the coexistence communication priority policy defines at least one dedicated sub-slot within at least one of an active group or a passive group of time slots for ESL communications.

Example 8. The method of any of examples 1-7, in which implementing the coexistence communication priority policy includes at least one of dynamic sub-slot reallocation or dynamic priority setting.

Example 9. The method of any of examples 1-8, in which the change in the ESL network communication operating mode involves a change to one of an onboarding of ESLs operating mode, a synchronization of ESLs operating mode, an ESL operating code update or setup operating mode, a stable ESL operating mode, or a default operating mode.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2L, and V2N, etc. Each of these technologies involves, for example, the transmission and reception of voice, data, signaling, and/or content messages. It should be understood that any references to terminology and/or technical details related to an individual telecommunication standard or technology are only for illustrative purposes and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, 7PROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method, performed by a processor of an access point (AP), for managing communications of an electronic shelf label (ESL) network and a wireless local area network (WLAN) supported by the AP, comprising:
implementing a coexistence communication priority policy for communications with ESLs and the WLAN in response to a change in an ESL network operating mode;
sharing the coexistence communication priority policy with WLAN firmware of the AP; and
using the coexistence communication priority policy in the communications with the ESLs.

2. The method of claim 1, wherein implementing the coexistence communication priority policy alters allocations of sub-slots within a frame structure of an ESL protocol to adjust a ratio of time available for packet transmissions in the WLAN and transmissions to and from the ESLs.

3. The method of claim 1, further comprising selecting the coexistence communication priority policy from predefined sets of coexistence communication priority policies stored in the AP, wherein each of the predefined sets of coexistence communication priority policies is customized for different ESL network communication scenarios.

4. The method of claim 3, wherein each set of coexistence communication priority policies defines a priority level of WLAN or ESL communications based on traffic loads for different types of traffic between the WLAN and the ESLs.

5. The method of claim 1, wherein the coexistence communication priority policy is configured to enable an ESL to transmit during a WLAN packet transmission or reception time.

6. The method of claim 1, wherein the coexistence communication priority policy is configured to enable the WLAN to transmit during an ESL sub-slot.

7. The method of claim 1, wherein the coexistence communication priority policy defines at least one dedicated sub-slot within at least one of an active group or a passive group of time slots for ESL communications.

8. The method of claim 1, wherein implementing the coexistence communication priority policy includes at least one of dynamic sub-slot reallocation or dynamic priority setting.

9. The method of claim 1, wherein the change in the ESL network communication operating mode involves a change to one of an onboarding of ESLs operating mode, a synchronization of ESLs operating mode, an ESL operating code update or setup operating mode, a stable ESL operating mode, or a default operating mode.

10. An access point (AP), comprising:
a first transceiver configured to communicate with an electronic shelf label (ESL);
a second transceiver configured to communicate with a wireless local area network (WLAN); and
a processor coupled to the first transceiver and the second transceiver, and configured to:
implement a coexistence communication priority policy for communications with ESLs and the WLAN in response to a change in an ESL network operating mode;
share the coexistence communication priority policy with WLAN firmware of the AP; and
use the coexistence communication priority policy in the communications with the ESLs.

11. The AP of claim 10, wherein the processor is further configured to implement the coexistence communication priority policy to alter allocations of sub-slots within a frame structure of an ESL protocol to adjust a ratio of time available for packet transmissions in the WLAN and transmissions to and from the ESLs.

12. The AP of claim 10, wherein the processor is further configured to select the coexistence communication priority policy from predefined sets of coexistence communication priority policies stored in the AP, wherein each of the predefined sets of coexistence communication priority policies is customized for different ESL network communication scenarios.

13. The AP of claim 12, wherein each set of coexistence communication priority policies defines a priority level of WLAN or ESL communications based on traffic loads for different types of traffic between the WLAN and the ESLs.

14. The AP of claim 10, wherein the processor is further configured to configure the coexistence communication priority policy to enable an ESL to transmit during a WLAN packet transmission or reception time.

15. The AP of claim 10, wherein the processor is further configured to configure the coexistence communication priority policy to enable the WLAN to transmit during an ESL sub-slot.

16. The AP of claim 10, wherein the processor is further configured to configure the coexistence communication priority policy to define at least one dedicated sub-slot within at least one of an active group or a passive group of time slots for ESL communications.

17. The AP of claim 10, wherein the processor is further configured to implement the coexistence communication priority policy including at least one of dynamic sub-slot reallocation or dynamic priority setting.

18. The AP of claim 10, wherein the processor is further configured to implement the coexistence communication priority policy in response to a change to one of an onboarding of ESLs operating mode, a synchronization of ESLs operating mode, an ESL operating code update or setup operating mode, a stable ESL operating mode, or a default operating mode.

19. An access point (AP), comprising:
a first transceiver configured to communicate with an electronic shelf label (ESL);
a second transceiver configured to communicate with a wireless local area network (WLAN);
means for implement a coexistence communication priority policy for communications with ESLs and the WLAN in response to a change in an ESL network operating mode;
means for sharing the coexistence communication priority policy with WLAN firmware of the AP; and
means for using the coexistence communication priority policy in the communications with the ESLs.

20. The AP of claim 19, wherein means for implementing the coexistence communication priority policy alters allocations of sub-slots within a frame structure of an ESL protocol to adjust a ratio of time available for packet transmissions in the WLAN and transmissions to and from the ESLs.

21. (canceled)

22. (canceled)

23. (canceled)

24. (canceled)

25. (canceled)

26. (canceled)

27. (canceled)

28. (canceled)

29. (canceled)

30. (canceled)
